(19) United States
(12) Patent Application Publication
(10) Pub. No.: US 2018/0103197 A1
(43) Pub. Date: Apr. 12, 2018

(54) Automatic Generation of Video Using Location-Based Metadata Generated from Wireless Beacons

(71) Applicant: GoPro, Inc., San Mateo, CA (US)

(72) Inventors: Scott Patrick Campbell, Belmont, CA (US); Timothy Macmillan, LaHonda, CA (US); David A. Newman, San Diego, CA (US); Balineedu Chowdary Adsumilli, San Mateo, CA (US)

(21) Appl. No.: 15/287,405

(22) Filed: Oct. 6, 2016

(51) Int. Cl. H04N 5/232; G06K 9/00; H04W 4/02; H04N 5/247; G06F 17/30

(52) U.S. Cl. CPC H04N 5/23238; G06K 9/00288; H04W 4/023; G06F 17/30837; G06K 9/00228; G06K 9/00577; G06F 17/3082; H04N 5/247

(57) ABSTRACT

A spherical content capture system captures spherical video content. A spherical video sharing platform enables users to share the captured spherical content and enables users to access spherical content shared by other users. In one embodiment, captured metadata provides proximity information indicating which cameras were in proximity to a target device during a particular time frame. The platform can then generate an output video from spherical video captured from those cameras. The output video may include a non-spherical reduced field of view such as those commonly associated with conventional camera systems. Particularly, relevant sub-frames having a reduced field of view may be extracted from frames of one or more spherical videos to generate an output video that tracks a particular individual or object of interest.

### BACKGROUND

### Technical Field

This disclosure relates to a media content system, and more specifically, to a media content system using spherical video.

### Description of the Related Art

In a spherical video capture system, a video camera system (which may include multiple video cameras) captures video in a 360 degree field of view along a horizontal axis and 180 degree field of view along the vertical axis, thus capturing the entire environment around the camera system in every direction. Current spherical video systems have not gained widespread use because high resolution, high frame rate video captured by such systems are extremely large and difficult to process and manage.

### BRIEF DESCRIPTIONS OF THE DRAWINGS

The disclosed embodiments have other advantages and features which will be more readily apparent from the following detailed description and the appended claims, when taken in conjunction with the accompanying drawings, in which:

FIG. 1 illustrates an example representation of a spherical video and a non-spherical video generated from the spherical content.

FIG. 2 illustrates an example embodiment of a media content system.

FIG. 3 illustrates an example architecture of a camera.

FIG. 4 illustrates a side view of an example embodiment of a camera.

FIG. 5 illustrates an example embodiment of a video server.

FIG. 6 illustrates an example embodiment of a process for generating an output video relevant to a target device from one or more spherical videos.

FIG. 7 illustrates an example of paths taken by a target device and cameras through an environment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A spherical content capture system may capture spherical video content. A spherical video sharing platform may enable users to share the captured spherical content and may enable users to access spherical content shared by other users. A spherical camera may capture everything or nearly everything in the surrounding environment (e.g., 360 degrees in the horizontal plane and 180 degrees in the vertical plane or close to it). While only a small portion of the captured content may be relevant to operator of the camera, the remainder of the captured content may be relevant to a community of other users. For example, any individuals that were in the vicinity of a spherical camera capturing spherical video content may appear somewhere in the captured content, and may therefore be interested in the content. Thus, any captured spherical content may be meaningful to a number of different individuals and a community of users may benefit from sharing of spherical video content. As one example, a group of people may each record their actions on a spherical camera and may each allow shared access to the captured content. Each individual in the group may then be capable of extracting relevant and meaningful content from a shared capture, different portions of which may be relevant to different members of the group or others outside of the group.

In one embodiment, location or other types of metadata, audio/visual features, or a combination of metadata an audio/visual features may be used to identify content relevant to a particular user (e.g., based on time and location information). The platform can then generate an output video from one or more shared spherical content files relevant to the user. The output video may include a non-spherical reduced field of view such as those commonly associated with conventional camera systems (e.g., a 120 degree by 67 degree field of view). For example, relevant sub-frames having reduced fields of view may be extracted frames of one or more spherical videos to generate the output video. For example, sub-frames may be selected to generate an output video that track a particular individual, object, scene, or activity of interest. The output video thus may reduce the captured spherical content to a standard field of view video having the content of interest while eliminating extraneous data outside the targeted field of view. As will be apparent, many different output videos can be generated from the same set of shared spherical video content.

In a particular embodiment, a method may include receiving captured proximity data corresponding to a target device, in which the proximity data may indicate for a time frame, camera identifiers associated with a plurality of cameras from which respective beacon signals were detected by of the target device during the time frame. Furthermore, the proximity data may indicate first signal strengths associated with the beacon signals received from each of the first plurality of cameras. Based on the signal strengths, a first selected camera having a highest signal strength may be determined for the time frame. A video database may then be queried for video captured during the time frame by the selected camera to obtain a spherical video captured during the time frame by the selected camera. Each frame of the spherical video corresponding to the time frame may be processed to identify a sequence of sub-frames corresponding to a location of the target device relative to the selected camera during the time frame. The sequence of sub-frames may have a reduced field of view relative to a field of view of the spherical video. A portion of the output video comprising the sequence of sub-frames may then be outputted.

In another particular embodiment, a non-transitory computer-readable storage medium may store instructions that when executed by a processor cause the process to perform steps including the method steps described above.

In another particular embodiment, a video server may include a processor a non-transitory computer-readable storage medium may store instructions that when executed by the processor cause the process to perform steps including the method steps described above.

Additional embodiments are described in further detail below.

### Generation of Output Video from Spherical Content

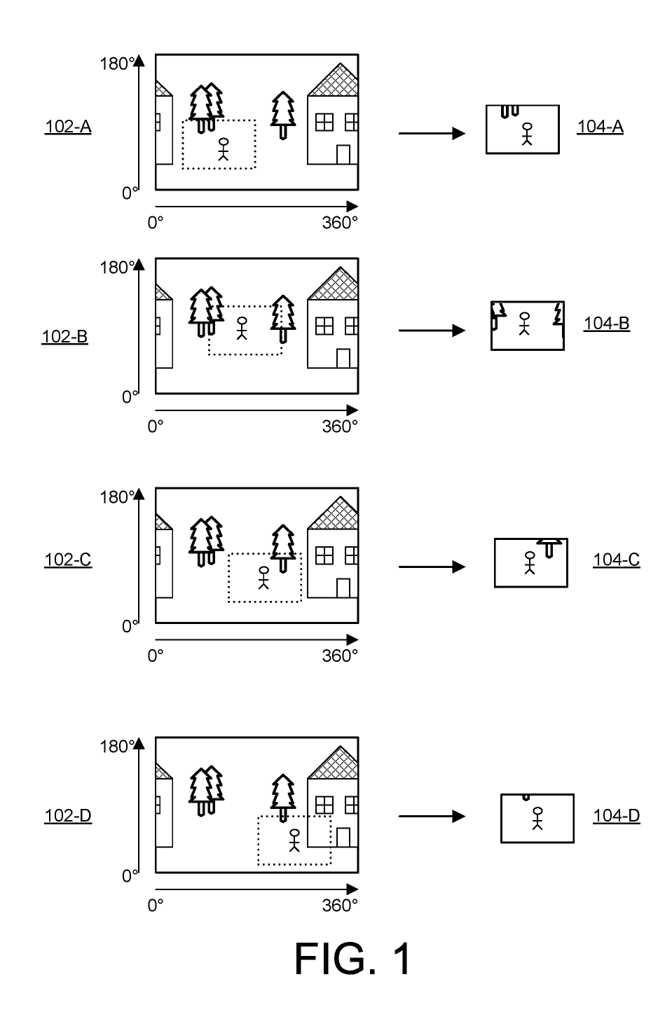

FIG. 1 illustrates an example representation of a spherical video illustrated as a sequence of spherical video frames 102 (e.g., frames 102-A, 102-B, 102-C, 102-D). In the illustrated embodiment, the spherical video frames 102 may be projected to a rectangular image. In practice, the spherical video may be encoded in any of a number of possible file formats including circular formats, rectangular formats, oval formats, etc. As can be seen, because spherical video captures in every direction, the captured scene may wrap around the edges (e.g., the house in FIG. 1 may be approximately 180 degrees from the center of the image from the perspective of the camera). To generate the output video, a relevant sub-frame 104 may be extracted from each of the spherical frames 102 (e.g., sub-frames that track the path of the person). Thus, the output video may have a non-spherical (e.g., standard) field of view and may provide the appearance of a camera panning across the scene to track the person's path. As can be seen, different output videos could be created from the same raw spherical video by extracting different sequences of sub-frames that depict other individuals or objects of interest.

In one embodiment, a community content sharing platform may enable individuals to subscribe to a community of users. The subscribers may be provided access to video captured by not only themselves but also the wider group. The community content sharing platform may effectively be a public open-source resource for everyone to find and use meaningful content of themselves from a plurality of different spherical camera sources. As the number of shared videos in the sharing platform increases, the likelihood of users being able to find videos of relevance may increase substantially.

### Example Spherical Media Content System

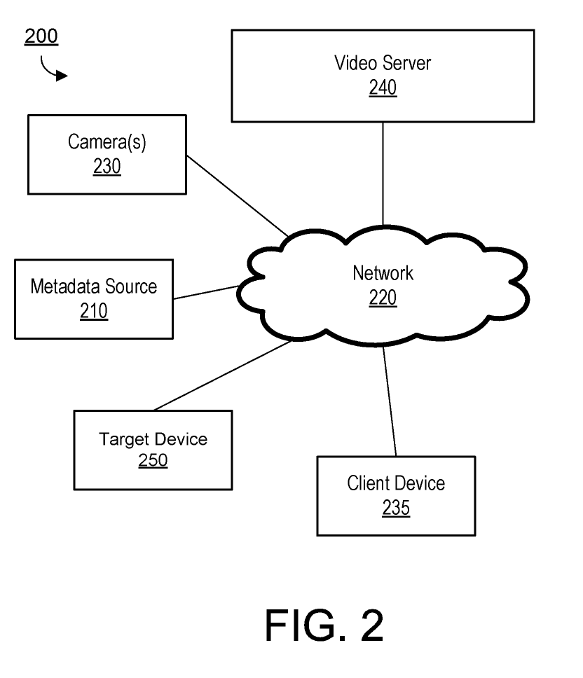

FIG. 2 is a block diagram of a media content system 200, according to one example embodiment. The media content system 200 may include one or more metadata sources 210, a network 220, one or more cameras 230, a client device 235, a video server 240, and a target device. In alternative configurations, different and/or additional components may be included in the media content system 200. Examples of metadata sources 210 may include sensors (such as accelerometers, speedometers, rotation sensors, GPS sensors, altimeters, and the like), camera inputs (such as an image sensor, microphones, buttons, and the like), and data sources (such as clocks, external servers, web pages, local memory, and the like). In some embodiments, one or more of the metadata sources 210 can be included within the camera 230. Alternatively, one or more of the metadata sources 210 may be integrated with a client device 235 or another computing device such as, for example, a mobile phone.

The one or more cameras 230 can include a camera body, one or more a camera lenses, various indicators on the camera body (such as LEDs, displays, and the like), various input mechanisms (such as buttons, switches, and touch-screen mechanisms), and electronics (e.g., imaging electronics, power electronics, metadata sensors, etc.) internal to the camera body for capturing images via the one or more lenses and/or performing other functions. One or more cameras 230 may be capable of capturing spherical or substantially spherical content. As used herein, spherical content may include still images or video having spherical or substantially spherical field of view. For example, in one embodiment, the camera 230 may capture video having a 360 degree field of view in the horizontal plane and a 180 degree field of view in the vertical plane. Alternatively, the camera 230 may capture substantially spherical video having less than 360 degrees in the horizontal direction and less than 180 degrees in the vertical direction (e.g., within 10% of the field of view associated with fully spherical content).

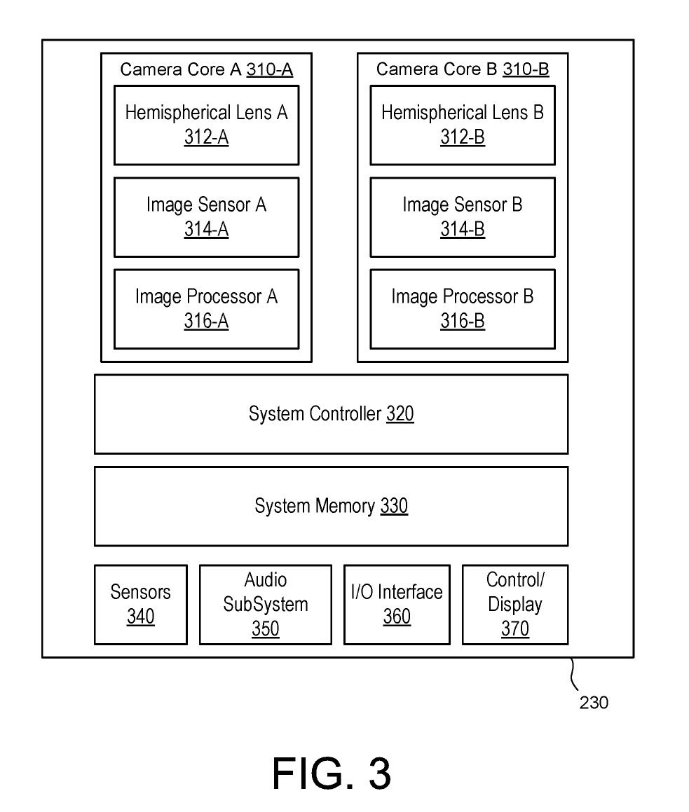

As described in greater detail in conjunction with FIG. 3 below, the camera 230 can include sensors to capture metadata associated with video data, such as timing data, motion data, speed data, acceleration data, altitude data, GPS data, and the like. In a particular embodiment, various metadata can be incorporated into a media file together with the captured spherical content. This metadata may be captured by the camera 230 itself or by another device (e.g., a mobile phone) proximate to the camera 230. In one embodiment, the metadata may be incorporated with the content stream by the camera 230 as the spherical content is being captured. In another embodiment, a metadata file separate from the spherical video file may be captured (by the same capture device or a different capture device) and the two separate files can be combined or otherwise processed together in post-processing.

The camera 230 may furthermore periodically send out wireless beacons (e.g., via Bluetooth, WiFi, or other wireless communication protocol) specifying a unique camera identifier associated with the camera. The beacons may be detected by other cameras 230 or the target device 250 and may be used to track which cameras 230 are in the vicinity at any given time.

The target device 250 may comprise an electronic device such as a cell phone, dedicated tracking device, or another camera. The target device 250 is typically carried or attached to a user and captures absolute or relative location information that may be used to determine its position relative to the position of the one or more cameras 230 at any given time. For example, the target device 250 may receive the wireless beacons sent by the cameras 230 and record a time-stamped camera identifier of each received beacon and the signal strength of the beacon signal. The signal strength may be used in post-processing to estimate which camera 230 is closest to the target device 250 at any given time. The target device 250 may store this position data as a metadata file or may embed the metadata in a video file.

The video server 240 may receive and stores videos captured by the camera 230 and may allow users to access shared videos at a later time. In one embodiment, the video server 240 may provide the user with an interface, such as a web page or native application installed on the client device 235, to interact with and/or edit the stored videos and to automatically generate output videos relevant to a particular user (or a specified set of parameters) from one or more stored spherical videos. The output videos may have a reduced field of view relative to the original spherical videos. For example, an output video may have a field of view consistent with that of a conventional non-spherical camera such as, for example, a 120 degree by 67 degree field of view. To generate the output video, the video server 240 may extract a sequence of relevant sub-frames having the reduced field of view from frames of one or more spherical videos. For example, sub-frames may be selected from one or more spherical videos to generate an output video that tracks a path of a particular individual or object. In one embodiment, the video server 240 can automatically identify sub-frames by identifying a spherical video that was captured by a camera near a particular location and time where an individual or object of interest was present. Because spherical content may be captured in all directions, the spherical video captured at the particular time and location when an individual or object was present may be highly likely to include sub-frames depicting the individual or object. Furthermore, because the original spherical video may comprise video captured in all directions, many different output videos can be generated from the same set of shared spherical video content.

In an embodiment, the video server 240 generates the output video based on input metadata from the target device 250 indicating the camera identifiers of the beacon signals it received and their signal strengths. The video server 240 can then determine which camera 230 was proximate to the target device 250 at any given time and automatically query a video database for video captured by those cameras 230 during the relevant time. Because the captured video may be spherical, the user carrying the target device 250 is likely to be present in any video captured by a camera within proximity. Based on the relative location information, the video server 240 can also determine a direction between the camera 230 and the target device 250 at a given time and thereby select a sub-frame relevant to the user. In other embodiments, output videos may be generated based on two or more spherical video files shared on the video server 240.

As one example use case scenario, a skier at a ski resort may use an application on his mobile phone as a target device 250 to track which cameras 230 were around the skier at various times throughout the day. One or more other users capture spherical video content one the same day at the same ski resort and share the spherical content on the video server, some of which will depict the skier. By correlating the metadata from the target device 250 with the spherical video in the database, the video server can automatically locate a sequence of sub-frames from one or more of the spherical videos that depict the skier and follow his path through the resort. Further still, other skiers can input different sets of metadata and obtain their own customized videos from a common set of captured spherical content. If multiple skiers record and share spherical content, the volume of relevant video for any individual skier may be multiplied. Thus, as the size of the sharing community increases, the relevance of the spherical content to any giving user may increase rapidly.

A user can interact with interfaces provided by the video server 240 via the client device 235. The client device 235 may comprise any computing device capable of receiving user inputs as well as transmitting and/or receiving data via the network 220. In one embodiment, the client device 235 may be a conventional computer system, such as a desktop or a laptop computer. Alternatively, the client device 235 may be a device having computer functionality, such as a personal digital assistant (PDA), a mobile telephone, a smartphone or another suitable device. The user can use the client device 235 to view and interact with or edit videos stored on the video server 240. For example, the user can view web pages including video summaries for a set of videos captured by the camera 230 via a web browser on the client device 235.

One or more input devices associated with the client device 235 may receive input from the user. For example, the client device 235 can include a touch-sensitive display, a keyboard, a trackpad, a mouse, a voice recognition system, and the like. In some embodiments, the client device 235 can access video data and/or metadata from the camera 230 or one or more metadata sources 210, and can transfer the accessed metadata to the video server 240. For example, the client device may retrieve videos and metadata associated with the videos from the camera via a universal serial bus (USB) cable coupling the camera 230 and the client device 235. The client device 235 can then upload the retrieved videos and metadata to the video server 240. In one embodiment, the client device 235 may interact with the video server 240 through an application programming interface (API) running on a native operating system of the client device 235, such as IOS® or ANDROID™. While FIG. 2 shows a single client device 235, in various embodiments, any number of client devices 235 may communicate with the video server 240.

The video server 240 may communicate with the client device 235, the metadata sources 210, and the camera 230 via the network 220, which may include any combination of local area and/or wide area networks, using both wired and/or wireless communication systems. In one embodiment, the network 220 may use standard communications technologies and/or protocols. In some embodiments, all or some of the communication links of the network 220 may be encrypted using any suitable technique or techniques. It should be noted that in some embodiments, the video server 240 may be located within the camera 230 itself.

Various components of the environment 200 of FIG. 2 such as the camera 230, metadata source 210, video server 240, and client device 225 can include one or more processors and a non-transitory computer-readable storage medium storing instructions therein that when executed cause the processor to carry out the functions attributed to the respective devices described herein.

### Example Camera Configuration

FIG. 3 is a block diagram illustrating a camera 230, according to one embodiment. In the illustrated embodiment, the camera 230 may comprise two camera cores 310 (e.g., camera core A 310-A and camera core B 310-B) each comprising a hemispherical lens 312 (e.g., hemispherical lens 312-A and hemispherical lens 312-B), an image sensor 314 (e.g., image sensor 314-A and image sensor 314-B), and an image processor 316 (e.g., image processor 316-A and image processor 316-B). The camera 230 may additionally includes a system controller 320 (e.g., a microcontroller or microprocessor) that controls the operation and functionality of the camera 230 and system memory 330 that may be configured to store executable computer instructions that, when executed by the system controller 320 and/or the image processors 316, perform the camera functionalities described herein.

An input/output (I/O) interface 360 may transmit and receive data from various external devices. For example, the I/O interface 360 may facilitate the receiving or transmitting video or audio information through an I/O port. Examples of I/O ports or interfaces may include USB ports, HDMI ports, Ethernet ports, audioports, and the like. Furthermore, embodiments of the I/O interface 360 may include wireless ports that can accommodate wireless connections. Examples of wireless ports may include Bluetooth, Wireless USB, Near Field Communication (NFC), and the like. The I/O interface 360 may also include an interface to synchronize the camera 230 with other cameras or with other external devices, such as a remote control, a second camera 230, a smartphone, a client device 335, or a video server 340. The I/O interface 360 may furthermore output periodic beacons via one or more of the wireless ports that broadcasts a camera identifier associated with the camera 230. Furthermore, the I/O interface may receive beacons from other cameras. The camera identifiers and signal strengths associated with the received beacons may be stored to system memory 330.

A control/display subsystem 370 may include various control a display components associated with operation of the camera 230 including, for example, LED lights, a display, buttons, microphones, speakers, and the like. The audio subsystem 350 may include, for example, one or more microphones and one or more audio processors to capture and process audio data correlated with video capture. In one embodiment, the audio subsystem 350 may include a microphone array having two or microphones arranged to obtain directional audio signals.

Sensors 340 may capture various metadata concurrently with, or separately from, video capture. For example, the sensors 340 may capture time-stamped location information based on a global positioning system (GPS) sensor, and/or an altimeter. Other sensors 340 may be used to detect and capture orientation of the camera 230 including, for example, an orientation sensor, an accelerometer, a gyroscope, or a magnetometer. Sensor data captured from the various sensors 340 may be processed to generate other types of metadata. For example, sensor data from the accelerometer may be used to generate motion metadata, comprising velocity and/or acceleration vectors representative of motion of the camera 230. Furthermore, sensor data may be used to generate orientation metadata describing the orientation of the camera 230. Sensor data from the GPS sensor may provide GPS coordinates identifying the location of the camera 230, and the altimeter may measure the altitude of the camera 230. In one embodiment, the sensors 340 may be rigidly coupled to the camera 230 such that any motion, orientation or change in location experienced by the camera 230 may also be experienced by the sensors 340. The sensors 340 furthermore may associate a time stamp representing when the data was captured by each sensor. In one embodiment, the sensors 340 may automatically begin collecting sensor metadata when the camera 230 begins recording a video.

In alternative embodiments, one or more components of the camera cores 310 may be shared between different camera cores 310. For example, in one embodiment, the camera cores 310 may share one or more image processors 316. Furthermore, in alternative embodiments, the camera cores 310 may have additional separate components such as, for example, dedicated system memory 330 or system controllers 320. In yet other embodiments, the camera 230 may have more than two camera cores 310 or a single camera core with a 360° lens or a single hyper-hemi (super fish-eye) lens.

In one embodiment, the camera 230 may comprise a twin hyper-hemispherical lens system that capture two image hemispheres with synchronized image sensors which combine to form a contiguous spherical image. The image hemispheres may be combined based on, for example, a back-to-back configuration, a side-by-side configuration, a folded symmetrical configuration or a folded asymmetrical configuration. Each of the two streams generated by camera cores 310 may be separately encoded and then aggregated in post processing to form the spherical video. For example, each of the two streams may be encoded at 2880×2880 pixels at 30 frames per second and combined to generate a 5760×2880 spherical video at 30 frames per second. Other resolutions and frame rates may also be used.

In an embodiment the spherical content may be captured at a high enough resolution to guarantee the desired output from the relevant sub-frame will be of sufficient resolution. For example, if a horizontal field of view of 120° at an output resolution of 1920×1080 pixels is desired in the final output video, the original spherical capture may include a horizontal 360° resolution of at least 5760 pixels (3×1920).

In one embodiment, a 5.7K spherical file format may provide 16 megapixel resolution. This may provide a resolution of approximately one pixel per inch at a distance of 23 meters (76 feet) from the camera 230. In this embodiment, spherical video may be captured as a 5760 pixels by 2880 pixels with a 360 degree horizontal field of view and a 180 degree vertical field of view. In one embodiment, the image sensor may capture 6 k×3 k image to provide six degrees of overlap and 4 degrees of out-of-field image to avoid worst modulation transfer function (MTF) region from the lens. From the spherical image frames, a 1920×1080 sub-frame may be extracted that provides a 120 degree by 67.5 degree field of view. As described above, the location of the sub-frame may be selected to capture sub-frames of interest to a given user. In one embodiment, each of two image sensors captures a 3 k×3 k image which may be encoded as 2880×2880 images. The images may be combined to create the 5760×2880 spherical image.

In another embodiment, a 720p file format may be used. Here, spherical video may be represented as 4000 pixels by 2000 pixels with a 360 degree horizontal field of view and a 180 degree vertical field of view. In one embodiment, the 4 k×2 k image may be based on a 4000 pixels×2250 pixels image captured by the image sensor to provide some overlap in the vertical direction. From the spherical image frames, a 720×1280 sub-frame may be extracted from each frame that provides a 115 degree by 65 degree field of view.

In one embodiment, the camera 230 may include a computational image processing chip that aggregates the two data streams into one encoding internally to the camera 230. The camera 230 can then directly output the spherical content or a downscaled version of it. Furthermore, in this embodiment, the camera 230 may directly output sub-frames of the captured spherical content having a reduced field of view based on user control inputs specifying the desired sub-frame locations.

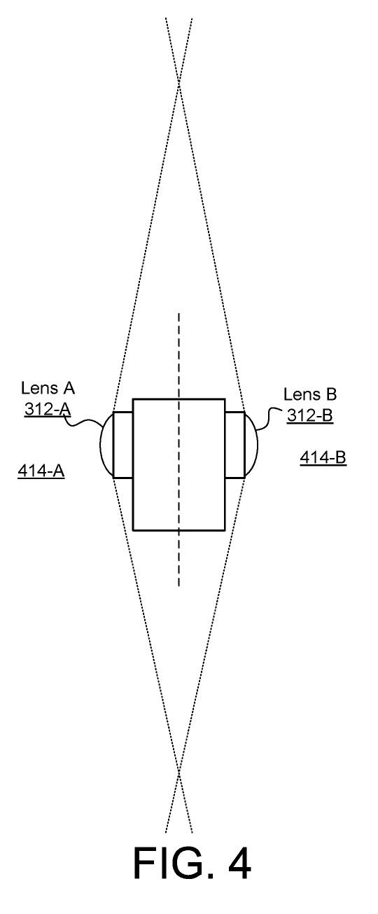

FIG. 4 illustrates a side view of an example camera 230. As can be seen, the camera 230 may include a first hemispherical lens 312-A capturing a first field of view 414-A and a second hemispherical lens 312-B capturing a second field of view 414-B. The fields of view 414-A, 414-B may be stitched together in the camera 230 or in post-processing to generate the spherical video.

### Example Video Server Architecture

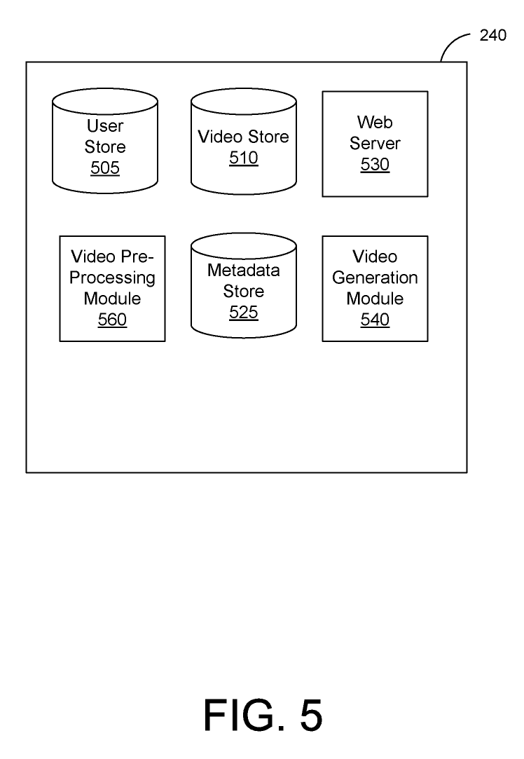

FIG. 5 is a block diagram of an architecture of the video server 240. In the illustrated embodiment, the video server 240 may comprise a user storage 505, a video storage 510, a metadata storage 525, a web server 530, a video generation module 540, and a video pre-processing module 560. In other embodiments, the video server 240 may include additional, fewer, or different components for performing the functionalities described herein. Conventional components such as network interfaces, security functions, load balancers, failover servers, management and network operations consoles, and the like are not shown so as to not obscure the details of the system architecture.

In an embodiment, the video server 240 may enable users to create and manage individual user accounts. User account information is stored in the user storage 505. A user account may include information provided by the user (such as biographic information, geographic information, and the like) and may also include additional information inferred by the video server 240 (such as information associated with a user's historical use of a camera and interactions with the video server 240). Examples of user information may include a username, contact information, a user's hometown or geographic region, other location information associated with the user, other users linked to the user as “friends,” and the like. The user storage 505 may include data describing interactions between a user and videos captured by the user. For example, a user account can include a unique identifier associating videos uploaded by the user with the user's user account. Furthermore, the user account can include data linking the user to other videos associated with the user even if the user did not necessarily provide those videos. For example, the user account may link the user to videos having location metadata matching the user's location metadata, thus indicating that the video was captured at a time and place where the user was present and the user is therefore highly likely to be depicted somewhere in the video.

The video storage 510 may store videos captured and uploaded by users of the video server 240. The video server 240 may access videos captured using the camera 230 and may store the videos in the video storage 510. In one example, the video server 240 may provide the user with an interface executing on the client device 235 that the user may use to upload videos to the video storage 515. In one embodiment, the video server 240 may index videos retrieved from the camera 230 or the client device 235, and may store information associated with the indexed videos in the video store. For example, the video server 240 may provide the user with an interface to select one or more index filters used to index videos. Examples of index filters may include but are not limited to: the time and location that the video was captured, the type of equipment used by the user (e.g., ski equipment, mountain bike equipment, etc.), the type of activity being performed by the user while the video was captured (e.g., snowboarding, mountain biking, etc.), or the type of camera 230 used to capture the content.

In some embodiments, the video server 240 may generate a unique identifier for each video stored in the video storage 510 which may be stored as metadata associated with the video in the metadata storage 525. In some embodiments, the generated identifier for a particular video may be unique to a particular user. For example, each user may be associated with a first unique identifier (such as a 10-digit alphanumeric string), and each video captured by a user may be associated with a second unique identifier made up of the first unique identifier associated with the user concatenated with a video identifier (such as an 8-digit alphanumeric string unique to the user). Thus, each video identifier may be unique among all videos stored at the video storage 510, and may be used to identify the user that captured the video.

In some embodiment, in addition to being associated with a particular user, a video may be associated with a particular community. For example, the video provider may choose to make the video private, make the video available with the entire public, or make the video available to one or more limited specified community such as, for example, the user's friends, co-workers, members in a particular geographic region, etc.

The metadata storage 525 may store metadata associated with videos stored by the video storage 510 and with users stored in the user storage 505. Particularly, for each video, the metadata storage 525 may store metadata including time-stamped location information, if available, associated with each frame of the video to indicate the location of the camera 230 at any particular moment during capture of the spherical content. Furthermore, the metadata may store camera identifiers and signal strengths associated with beacon signals it received from other cameras 230 during capture of the video. Additionally, the metadata storage 525 may store other types of sensor data captured by the camera 230 in association with a video including, for example, gyroscope data indicating motion and/or orientation of the device. In some embodiments, metadata corresponding to a video may be stored within a video file itself, and not in a separate storage module. The metadata storage 525 may also store time-stamped location information associated with a particular user so as to represent a user's physical path during a particular time interval. This data may be obtained from a camera held by the user, a mobile phone application that tracks the user's path, or another metadata source.

The web server 530 provides a communicative interface between the video server 240 and other entities of the environment of FIG. 2. For example, the web server 530 can access videos and associated metadata from the camera 230 or the client device 235 to store in the video storage 510 and the metadata storage 525, respectively. The web server 530 can also receive user input provided to the client device 235, can request automatically generated output videos relevant to the user generated from the stored spherical video content as will be described below. The web server 530 may furthermore include editing tools to enables users to edit videos stored in the video storage 510.

A video pre-processing module 560 may pre-process and index uploaded videos. For example, in one embodiment, uploaded videos may be automatically processed by the video pre-processing module 560 to conform the videos to a particular file format, resolution, etc. Furthermore, in one embodiment, the video pre-processing module 560 may automatically parse the metadata associated with videos upon being uploaded in order to index the videos to a searchable index (e.g, by camera identifier, time, location, etc.).

The video generation module 540 may automatically generate output videos relevant to a user or to a particular set of input parameters. For example, the video generation module 540 may generate an output video including content that tracks a physical path of a target device 250 over a particular time interval. The output videos may have a reduced field of view (e.g., a standard non-spherical field of view) and represent relevant sub-frames to provide a video of interest. For example, the video may track a particular path of an individual, object, or other target so that each sub-frame depicts the target as the target moves through a given scene. In one embodiment, the video generation module 540 may operate in response to a user querying the video server 240 with particular input criteria. In another embodiment, the video generation module 540 may automatically generate videos relevant to users of the community based on metadata or profile information associated with user and may automatically provide the videos to the user when it is identified as being relevant to the user (e.g., via their web portal, via email, via text message, or other means).

In an embodiment, content manipulation may be performed on the video server 240 with edits and playback using only the original source content. In this embodiment, when generating an output video, the video server 140 may save an edit map indicating, for each frame of the output video, the original spherical video file from which the sub-frame was extracted and the location of the sub-frame. The edit map may furthermore store any processing edits performed on the video such as, for example, image warping, image stabilization, output window orientation, image stitching changes in frame rate or formatting, audio mixing, effects, etc. In this embodiment, no copying, storing, or encoding of a separate output video sequences may be necessary. This beneficially may minimize the amount of data handled by the server. When users view a previously saved output video, the server 240 may re-generate the output video based on the saved edit map by retrieving the relevant sub-frames from the original source content. Alternatively, the user may select to download a copy of the output video, for storing in the user's local storage.

In an embodiment, the user interface may also provide an interactive viewer that enables the user to pan around within the spherical content being viewed. This may allow the user to search for significant moments to incorporate into the output video and manually edit the automatically generated video.

In one embodiment, the user interface may enable various editing effects to be added to a generated output video. For example, the video editing interface may enable effects such as, cut-away effects, panning, tilting, rotations, reverse angles, image stabilization, zooming, object tracking,

In one embodiment, spherical content may also be processed to improve quality. For example, in one embodiment, dynamic stabilization may be applied to stabilize in the horizontal, vertical, and rotational directions. Because the content is spherical, stabilization can be performed with no loss of image resolution. Stabilization can be performed using various techniques such as object tracking, vector map analysis, on-board gyro data, etc. For example, an in-view camera body can be used as a physical or optical reference for stabilization. Spherical content may also be processed to reduce rolling shutter artifacts. This may be performed using on-board gyro motion data or image analysis data. This processing is also lossless (i.e., no pixels are pushed out of the frame.). In this technique, horizontal pixel lines are rotated to re-align an image with the true vertical orientation. The technique may work for rotational camera motion within an environment (e.g., when the camera is spinning).

In one embodiment, to encourage users to share content, the platform may reward the user with credits when his/her content is accessed/used by other members of a group or community. Furthermore, a user may spend credits to access other content streams on the community platform. In this way, users are incentivized to carry a camera and to capture compelling content. If socially important spherical content is made available by a particular user, the user could generate an income-stream as people access that content and post their own edits.

### Operation of Spherical Media Content System

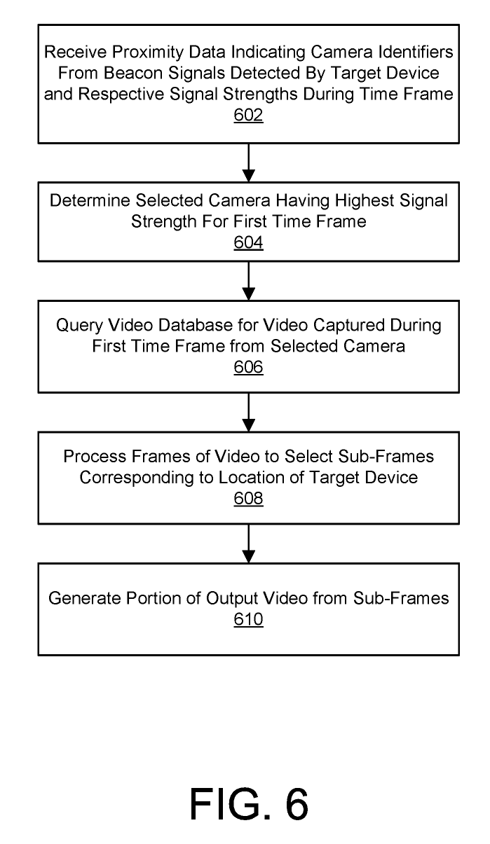

FIG. 6 illustrates an example embodiment of a process for automatically generating an output video relevant to a particular target device 250. Proximity data corresponding to a target device 250 may be received 602 at the video server 240. The proximity data may indicate, for each of a sequence of time ranges, any camera identifiers associated cameras from which beacon signals were detected by the target device 250 during that time range, and may indicate respective signal strengths associated with the received beacon signals. An example of proximity data for a given target device 250 is shown below in Table 1:

| | Camera Identifiers Detected: |
|---|---|
| Time Range | Signal Strengths |
| t₀-t₁ | A: 27, B: 14 |
| t₁-t₂ | A: 34, C: 6, D: 37 |
| t₂-t₃ | B: 22 |
| t₃-t₄ | None |

For example, the proximity data may indicate that during a first time range t₀-t₁, the target device 250 detected a beacon signal from a camera A with a signal strength of 27 and from a camera B with a signal strength of 14; during a second time range t₁-t₂, the target device 250 detected a beacon signal from the camera A with a signal strength of 34, from a camera C with a signal strength of 6, and from a camera D with a signal strength of 37; during a third time range t₂-t₃, the target device 250 detected a beacon signal from the camera B with a signal strength of 22; and during a fourth time range t₃-t₄, the target device 250 did not detect any beacon signals.

The proximity data may beneficially indicate which cameras were in the vicinity of a user carrying the target device 250 during any given time, using signal strength of the beacon signal as a metric for estimating proximity. The proximity data may be captured in real-time during the recorded time ranges and stored to a metadata file that can be uploaded to the video server 240. Alternatively, if the target device 250 is a camera, the proximity data may be stored as metadata in a video recorded by the camera during the time ranges rather than in a separate metadata file.

The video server 240 may then select 604 a camera for the given time range that has a highest signal strength during a given time range. Thus, in the example of Table 1, the video server 240 may select camera A for the time range t₀-t₁, select camera D for the time range t₁-t₂, and may select camera B for the time range t₂-t₃. Here, the camera associated with the highest signal strength is predicted to be the camera closest to the target device 250 during the relevant time frame and most likely to include video of interest to the user that was carrying the target device 250.

The video store 510 may then be queried 606 for video captured by the selected camera during the relevant time frame. For example, the video server 240 may query the video store 510 for video captured by camera A during the time range t₀-t₁ to obtain spherical video captured by camera A during that time. This video is likely to depict the user carrying the target device, since it was within the vicinity of the target device 250 during the relevant time frame and capturing spherical video content.

Each frame of the obtained spherical video in the relevant time range is then processed to identify sub-frames that correspond to the location of the target device 250 within the spherical frame. The sub-frames have a reduced field of view relative to a field of view of the spherical video. The location of the target device 250 within the spherical frame may be determined by a variety of different methods. For example, in one embodiment, GPS location data associated with the target device 250 may be compared with GPS location data associated with the camera. Orientation data from the camera may furthermore be used to determine orientation of the video. For example, the orientation data may comprise compass data to indicate which direction in the video corresponds to north, south, east, and west. Using the orientation data and the relative GPS coordinates, the relative direction between the camera location and the target device 250 location can be determined. The sub-frame may then be selected based on the determined direction.

In another embodiment, facial detection may be applied to the spherical video content to detect a location of a person within the spherical video, and the sub-frame may be selected based on the location of the person. If more than one person is present in the video, facial recognition may be used to recognize the user associated with the target device 250 (e.g., from a photograph the user uploaded to the video server 240).

In yet another embodiment, object recognition may be applied to the spherical video content to detect the target device 250 location or detect another object of interest known to be co-located with the target device 250.

In yet another embodiment a motion analysis may be performed to identify a region of motion having some particular characteristics that may be indicative of an activity of interest. For example, a motion thresholding may be applied to locate objects traveling according to a motion exceeding a particular velocity, acceleration, or distance.

In yet another embodiment, an audio analysis is performed on audio associated with the spherical video to determine a direction associated with a sound source. The direction of the sound source can then be correlated to a particular spatial position within the spherical video (using, for example, a known orientation of the camera determined based on sensor data or visual cues). The position of the sound source can then be identified and used to select the sub-frames. Furthermore, in one embodiment, speech recognition may be used to differentiate a sound of interest from background noise. For example, a user may speak a command such as “tag me” or state the user's name to indicate that the user's location in the video.

In yet another embodiment, in the case where the target device 250 is a camera that also captured video during the relevant time frame, features of the objects or scene that appear in both videos may be correlated and the relative position of the target device 250 to the other camera may be determined based on the overlapping capture.

In yet another embodiment, if multiple other cameras were in the vicinity of the camera from which the spherical video is taken, the signal strengths of the beacon signals received by the target device 250 from the other cameras, the signal strengths of the beacon signals received by the selected camera from the other cameras, and the beacon signals received by the other cameras from each other, the selected camera, and the target device 250 may be used to approximate distances between the multiple devices and triangulate position of the target device 250 relative to the selected camera.

In other embodiments, a location of a target feature may be manually identified.

In yet further embodiments, two or more of the techniques described above can be combined to identify a target feature of interest. For example, in one embodiment, different regions of the video may be scored based on a number of weighted metrics and a sub-frame corresponding to a target feature is chosen based on the weighted score.

An output video may then be generated 610 from the sub-frames. The process of FIG. 6 may repeat for different time ranges to generate a cohesive video. For example, a first set of sub-frames may be generated from camera A during the first time frame t₀-t₁ and a second set of sub-frames may be generated from camera D during the second time frame t₁-t₂. Thus, the process may automatically switch to the camera that was closest to the target device 250 at the time of capture and may select relevant sub-frames from each spherical frame to generate a cohesive output video relevant to the user carrying the target device 250.

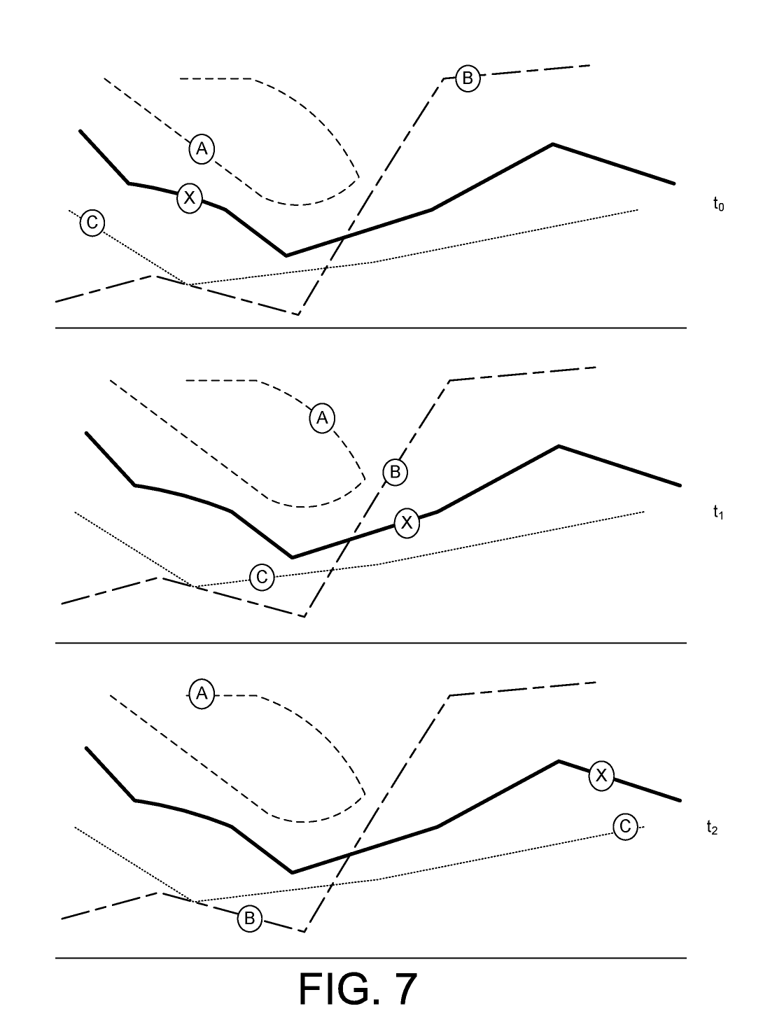

FIG. 7 illustrates examples of a path (“X”) of a target device 250 and paths of three example cameras in the vicinity of the target device 250. At a first time t₁, the target device X 250 is closest to camera A and thus video captured by camera A is most likely to be relevant to the user carrying the target device X 250. At a second time t₁, the target device X 250 is closest to camera B and thus video captured by camera B is most likely to be relevant to the user carrying the target device X 250. At a third time t₃, the target device X 250 is closest to camera C and thus video captured by camera C is most likely to be relevant to the user carrying the target device X 250.

In alternative embodiments, different metrics besides signal strength may be used to estimate the distances between cameras and the target device 250. For example, in one embodiment, relative GPS coordinates may be used. In another embodiment, a time-of-flight measurement may be used to determine the estimated distances. In other embodiments, visual or audio analysis may be used.

As described above, different portions of a given spherical video may be relevant to a large number of different users of the sharing community. In one embodiment, rather than the video server 240 storing individual output videos generated for each of its users, the video server can instead store an edit map specifying how the desired output video can be regenerated from the original raw spherical video. Then, the output video can be generated on request (e.g., in real-time) from the edit map when a user requests viewing. For example, the output video can be streamed to the user or the user can download the output video to the user's own local storage. An advantage of this approach is that individual output videos for specific users need not be stored by the video server 240, thus reducing its storage requirements. This storage savings may be significant because it is expected that a large number of personalized output videos may be generated from a relatively small number of shared spherical videos.

In one embodiment, the camera 230 may comprise a spherical or non-spherical camera 230 connected to an unmanned aerial vehicle (UAV). Because the camera 230 is able to capture a video over a relatively wide area, the video it captures is likely to be relevant to any users within the camera's field of view. In this case, the UAV or camera 230 receives beacon signals from one or more target devices 250 within range of the UAV and the UAV or camera 230 stores metadata relating to the received beacons as described above. Video captured by the UAV may then be automatically obtained based on the unique identifier associated with the target device 250.

In another embodiment, beacons captured by the UAV may cause the UAV to adjust its flight pattern in real-time based on a detected location of the target device 250. For example, the UAV may execute a flight pattern to incorporate various cinematography effects into the video, which may then be made available to the user of the target device 250.

### Additional Configuration Considerations

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for the described embodiments as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the scope defined in the appended claims.

What is claimed is:

1. A method for generating an output video, the method comprising:
receiving captured first proximity data corresponding to a target device, the first proximity data indicating for a first time frame, first camera identifiers associated with a first plurality of cameras from which respective first beacon signals were detected by of the target device during the first time frame and the first proximity data indicating first signal strengths associated with the first beacon signals received from each of the first plurality of cameras;
determining based on the first signal strengths, a first selected camera having a highest signal strength for the first time frame;
querying a video database for video captured during the first time frame by the first selected camera to obtain a first spherical video captured during the first time frame by the first selected camera;
processing each frame of the first spherical video corresponding to the first time frame to identify a first sequence of sub-frames corresponding to a first location of the target device relative to the first selected camera during the first time frame, the first sequence of sub-frames having a reduced field of view relative to a field of view of the first spherical video; and
generating a first portion of the output video comprising the first sequence of sub-frames.

2. The method of claim 1, further comprising:
receiving captured second proximity data corresponding to the target device, the second proximity data indicating for a second time frame, second camera identifiers associated with a second plurality of cameras that were detected to be within the threshold proximity of the target device during the second time frame and the second proximity data indicating second signal strengths associated with respective second beacon signals received from each of the second plurality of cameras;
determining based on the second signal strengths, a second selected camera having a highest signal strength for the second time frame;
querying the video database for video captured during the second time frame by the second selected camera to obtain a second spherical video captured during the second time frame by the second selected camera;
processing each frame of the second spherical video corresponding to the second time frame to identify a second sequence of sub-frames corresponding to a second location of the target device relative to the second selected camera during the second time frame, the second sequence of sub-frames having the reduced field of view relative to the field of view of the second spherical video; and
generating a second portion of the output video comprising the second sequence of sub-frames.

3. The method of claim 1, wherein processing each frame of the first spherical video corresponding to the first time frame to identify the first sequence of sub-frames corresponding to the first location of the target device relative to the first selected camera, comprises:
performing a facial recognition algorithm on the first spherical video to identify a face depicted in the first spherical video; and
determining the first location of the target device based on a location of the face.

4. The method of claim 1, wherein processing each frame of the first spherical video corresponding to the first time frame to identify the first sequence of sub-frames corresponding to the first location of the target device relative to the first selected camera, comprises:
performing an object recognition algorithm on first spherical video to recognize the target device depicted in the first spherical video.

5. The method of claim 1, wherein processing each frame of the first spherical video corresponding to the first time frame to identify the first sequence of sub-frames corresponding to the first location of the target device relative to the first selected camera, comprises:
performing an audio analysis of an audio track of the first spherical video to recognize an audio signal from the target device; and
determining the first location of the target device based on a direction of the audio signal.

6. The method of claim 1, wherein processing each frame of the first spherical video corresponding to the first time frame to identify the first sequence of sub-frames corresponding to the first location of the target device relative to the first selected camera, comprises
determining GPS positions of the target device and the first selected camera; and
determining the first location of the target device based on the GPS positions.

7. The method of claim 1, wherein the target device comprises a camera that captures video, wherein processing each frame of the first spherical video corresponding to the first time frame to identify the first sequence of sub-frames corresponding to the first location of the target device relative to the first selected camera, comprises
determining one or more matching objects recognized in the first spherical video from the selected camera and the video captured by the target device; and
determining the first location of the target device based on relative directions of the one or more matching objects in the first spherical video and the video captured by the target device.

8. The method of claim 1, wherein processing each frame of the first spherical video corresponding to the first time frame to identify the first sequence of sub-frames corresponding to the first location of the target device relative to the first selected camera, comprises:
determining estimated distances between the target device and one or more additional cameras and between the first selected camera and the one or more additional cameras, the estimated distances determined based on signal strengths of the beacon signals received by the one or more additional cameras; and
determining the first location of the target device based on the estimated distances.

9. A non-transitory computer-readable storage medium storing instructions for generating an output video, the instructions to cause the one or more processors to perform steps including:
indicating for a first time frame, first camera identifiers associated with a first plurality of cameras from which respective first beacon signals were detected by of the target device during the first time frame and the first proximity data indicating first signal strengths associated with the first beacon signals received from each of the first plurality of cameras;
determining based on the first signal strengths, a first selected camera having a highest signal strength for the first time frame;
querying a video database for video captured during the first time frame by the first selected camera to obtain a first spherical video captured during the first time frame by the first selected camera;
processing each frame of the first spherical video corresponding to the first time frame to identify a first sequence of sub-frames corresponding to a first location of the target device relative to the first selected camera during the first time frame, the first sequence of sub-frames having a reduced field of view relative to a field of view of the first spherical video; and
generating a first portion of the output video comprising the first sequence of sub-frames.

10. The non-transitory computer-readable storage medium of claim 9, wherein the instructions when executed further cause the one or more processors to perform steps including:
receiving captured second proximity data corresponding to the target device, the second proximity data indicating for a second time frame, second camera identifiers associated with a second plurality of cameras that were detected to be within the threshold proximity of the target device during the second time frame and the second proximity data indicating second signal strengths associated with respective second beacon signals received from each of the second plurality of cameras;
determining based on the second signal strengths, a second selected camera having a highest signal strength for the second time frame;
querying the video database for video captured during the second time frame by the second selected camera to obtain a second spherical video captured during the second time frame by the second selected camera;
processing each frame of the second spherical video corresponding to the second time frame to identify a second sequence of sub-frames corresponding to a second location of the target device relative to the second selected camera during the second time frame, the second sequence of sub-frames having the reduced field of view relative to the field of view of the second spherical video; and
generating a second portion of the output video comprising the second sequence of sub-frames.

11. The non-transitory computer-readable storage medium of claim 9, wherein processing each frame of the first spherical video corresponding to the first time frame to identify the first sequence of sub-frames corresponding to the first location of the target device relative to the first selected camera, comprises:
performing a facial recognition algorithm on the first spherical video to identify a face depicted in the first spherical video; and
determining the first location of the target device based on a location of the face.

12. The non-transitory computer-readable storage medium of claim 9, wherein processing each frame of the first spherical video corresponding to the first time frame to identify the first sequence of sub-frames corresponding to the first location of the target device relative to the first selected camera, comprises:
performing an object recognition algorithm on first spherical video to recognize the target device depicted in the first spherical video.

13. The non-transitory computer-readable storage medium of claim 9, wherein processing each frame of the first spherical video corresponding to the first time frame to identify the first sequence of sub-frames corresponding to the first location of the target device relative to the first selected camera, comprises:
performing an audio analysis of an audio track of the first spherical video to recognize an audio signal from the target device; and
determining the first location of the target device based on a direction of the audio signal.

14. The non-transitory computer-readable storage medium of claim 9, wherein processing each frame of the first spherical video corresponding to the first time frame to identify the first sequence of sub-frames corresponding to the first location of the target device relative to the first selected camera, comprises
determining GPS positions of the target device and the first selected camera; and
determining the first location of the target device based on the GPS positions.

15. The non-transitory computer-readable storage medium of claim 9, wherein the target device comprises a camera that captures video, wherein processing each frame of the first spherical video corresponding to the first time frame to identify the first sequence of sub-frames corresponding to the first location of the target device relative to the first selected camera, comprises
determining one or more matching objects recognized in the first spherical video from the selected camera and the video captured by the target device; and
determining the first location of the target device based on relative directions of the one or more matching objects in the first spherical video and the video captured by the target device.

16. The non-transitory computer-readable storage medium of claim 9, wherein processing each frame of the first spherical video corresponding to the first time frame to identify the first sequence of sub-frames corresponding to the first location of the target device relative to the first selected camera, comprises:
determining estimated distances between the target device and one or more additional cameras and between the first selected camera and the one or more additional cameras, the estimated distances determined based on signal strengths of the beacon signals received by the one or more additional cameras; and
determining the first location of the target device based on the estimated distances.

17. A video server for generating an output video, the video server comprising:
one or more processors; and
a non-transitory computer-readable storage medium storing instructions for generating an output video from spherical video content, the instructions to cause the one or more processors to perform steps including:
indicating for a first time frame, first camera identifiers associated with a first plurality of cameras from which respective first beacon signals were detected by of the target device during the first time frame and the first proximity data indicating first signal strengths associated with the first beacon signals received from each of the first plurality of cameras;
determining based on the first signal strengths, a first selected camera having a highest signal strength for the first time frame;
querying a video database for video captured during the first time frame by the first selected camera to obtain a first spherical video captured during the first time frame by the first selected camera;
processing each frame of the first spherical video corresponding to the first time frame to identify a first sequence of sub-frames corresponding to a first location of the target device relative to the first selected camera during the first time frame, the first sequence of sub-frames having a reduced field of view relative to a field of view of the first spherical video; and
generating a first portion of the output video comprising the first sequence of sub-frames.

18. The video server of claim 17, wherein the instructions when executed further cause the one or more processors to perform steps including:
receiving captured second proximity data corresponding to the target device, the second proximity data indicating for a second time frame, second camera identifiers associated with a second plurality of cameras that were detected to be within the threshold proximity of the target device during the second time frame and the second proximity data indicating second signal strengths associated with respective second beacon signals received from each of the second plurality of cameras;
determining based on the second signal strengths, a second selected camera having a highest signal strength for the second time frame;
querying the video database for video captured during the second time frame by the second selected camera to obtain a second spherical video captured during the second time frame by the second selected camera;
processing each frame of the second spherical video corresponding to the second time frame to identify a second sequence of sub-frames corresponding to a second location of the target device relative to the second selected camera during the second time frame, the second sequence of sub-frames having the reduced field of view relative to the field of view of the second spherical video; and
generating a second portion of the output video comprising the second sequence of sub-frames.

19. The video server of claim 17, wherein processing each frame of the first spherical video corresponding to the first time frame to identify the first sequence of sub-frames corresponding to the first location of the target device relative to the first selected camera, comprises:
performing a facial recognition algorithm on the first spherical video to identify a face depicted in the first spherical video; and
determining the first location of the target device based on a location of the face.

20. The video server of claim 17, wherein processing each frame of the first spherical video corresponding to the first time frame to identify the first sequence of sub-frames corresponding to the first location of the target device relative to the first selected camera, comprises:
performing an object recognition algorithm on first spherical video to recognize the target device depicted in the first spherical video.
